(19) United States
(12) Patent Application Publication
(10) Pub. No.: US 2007/0023231 A1
(43) Pub. Date: Feb. 1, 2007

(54) Lightweight safety harness

(76) Inventors: Patrick J. Gorman, White Lake, MI (US); Timothy L. Wilcox, North Branch, MI (US); Gerald DeMeyer, Rochester, MI (US)

Correspondence Address: HARNESS, DICKEY & PIERCE, P.L.C., P.O. BOX 828, BLOOMFIELD HILLS, MI, 48303, US

(21) Appl. No.: 11/493,367

(22) Filed: Jul. 26, 2006

Related U.S. Application Data
(60) Provisional application No. 60/702,687, filed on Jul. 26, 2005.

(51) Int. Cl. A62B 35/00

(52) U.S. Cl. 182/3

(57) ABSTRACT

A safety harness for a hunter is provided having two primary straps which wrap around the legs and shoulders of the user. A safety tether may be attached to the primary straps to provide support to the user and prevent falls. A climbing strap is attached to each primary strap, and provides support for the user while climbing a tree or other vertical structure. Loops are provided on the sides of the safety harness for attachment thereto of any variety of climbing ropes or supports.

### CROSS-REFERENCE TO RELATED APPLICATIONS

This application claims the benefit of U.S. Provisional Application No. 60/702,687, filed on Jul. 26, 2005. The disclosure of the above application is incorporated herein by reference.

### FIELD OF THE INVENTION

The present invention relates to a safety harness and, more particularly, to a safety harness for use during hunting to reduce injuries to the hunters due to accidental falls from a tree stand.

### BACKGROUND AND SUMMARY OF THE INVENTION

Hunting stands are frequently used by hunters and commonly referred to as hunting blinds, tree stands, tree-mounted hunting stands, and the like. The hunting stands can take many forms; some exemplary forms include tree-mounted stands, ground-based stands, and self-supported hunting stands. Further, tree stands offer various amenities contained within the stand; some exemplary amenities include seats, various stand adjustments, and mounting and storage locations for rifles, equipment and the like.

Many devices have been developed to secure the hunter in a hunting stand to improve hunter safety. As such, many devices address the scenario where the hunter installs the hunting stand above the ground. Examples of such installations include securing the hunting stand to a tree or constructing a self-supporting assembly to maintain the hunting stand above the ground. In the above examples, there is an important concern about the hunter falling from the tree stand to the ground. It is desirable to have a system allowing the hunter generally complete freedom of movement while in the tree stand. It is also desirable to provide a device that keeps the hunter safe if the hunter were to fall from the tree stand. Any safety harness must address and balance the competing interests of freedom of motion and safety during a fall. It has been suggested that seat belt retractors with associated webbing can be used to restrain a hunter. An example of one of these designs can be seen in US Patent Application No. 2004/0140158 herein incorporated by reference.

The harness is generally comprised of a single primary strap, which wraps around the shoulders and legs of the user. This is the primary load-bearing member of the harness which, in the event of a fall, supports the user from a rear tether strap, which attaches to the tree stand, blind, or other structural member. The rear tether strap is wrapped around the shoulder and leg strap, where it crosses over itself in back of the user. Thus, no other connecting hardware is necessary to secure the rear tether strap to the harness.

In one embodiment, the harness is further comprised of a climbing belt which is permanently stitched to one side of the harness, and at least one loop sewn to the other side of the harness capable of receiving the climbing belt's connecting hardware (i.e., carbiner, snap hook, etc.). The climbing belt and loop can thus be used to climb up a utility pole or tree to a stand or blind. The harness may be worn outside almost any clothing worn by the user. The harness may be used for industrial purposes or recreational purposes, such as hunting from a tree stand.

One of the major issues in proper use of a fall arrest harness is the proper installation to a user's body of the fall arrest harness. Many potential product users become confused with how to properly put on the fall arrest harness and do not properly install the harness to their body. This has the potential to expose them to the risk of more severe injuries or even death in the event of a fall. One potential method to make it easier for the user to understand how to properly install their harness is to package the product on a hanger or harness caddie. The caddie may be in the outline or shape of a human with the harness draped around it showing the proper way a person should wear the harness. This visual presentation will make it easy for the person to see how to put it on correctly. Another additional way to help clarify how to put the harness on properly is to place small identifying tags to key locations on the harness. The tags might be used for locations such as right shoulder, left shoulder, right chest, left chest, left leg inside, left leg outside, right leg inside, right leg outside, attaching tether and tree strap to name just a few possible locations to be identified. The tags would be especially helpful if the harness were not stored on the caddie, i.e. just thrown in a pile which does frequently occur. The tags can be of many different possible materials (possibly Tyvek or similar material) that will withstand a lifetime of use and remain attached and readable. Further enabling the user to put the harness on correctly is a “step-in” feature. The user may simply step into the harness and pull it up over their shoulders. This operation is similar to putting on a pair of pants, and makes it easier for the user to put the harness on correctly and quickly.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a frontal view of the harness as worn by a user;

FIG. 2 is a rear view of the harness as worn by a user;

FIG. 3 is a frontal view of the harness being put on by the user;

FIGS. 4A and 4B are a perspective view of the self-adjusting loop of the harness;

FIG. 5 is an alternate view of one embodiment of the present invention; and

FIGS. 6A-6E represent the steps of manufacturing the harness shown in FIG. 5.

### DETAILED DESCRIPTION OF THE PREFERRED EMBODIMENTS

The following description of the preferred embodiments is merely exemplary in nature and is in no way intended to limit the invention, its application, or uses.

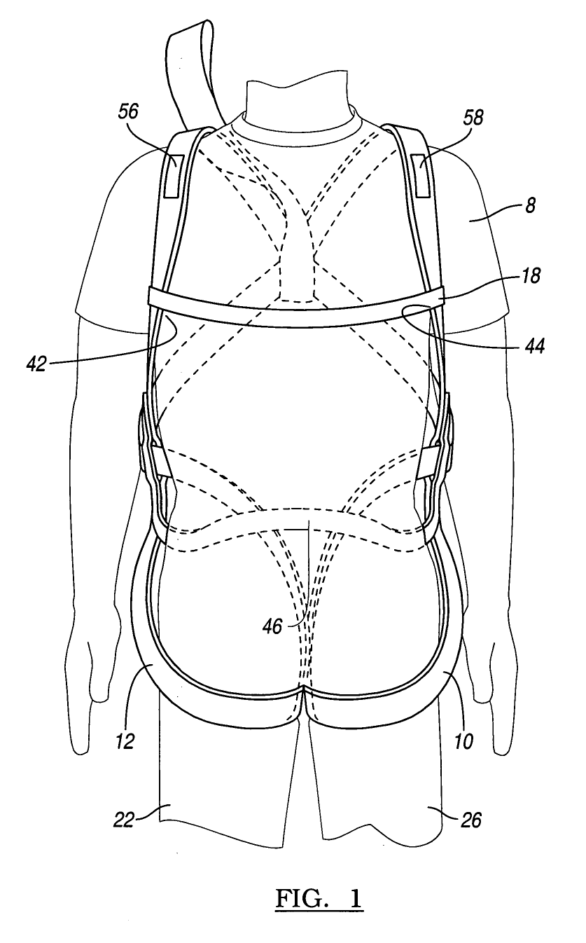

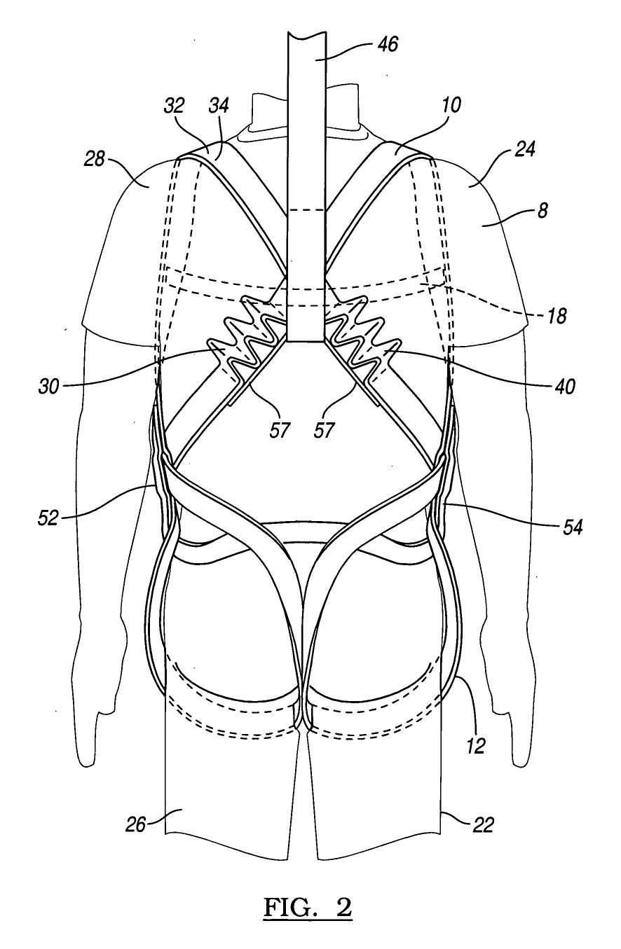

FIGS. 1-2 show the harness 10 which is worn by a user 8. The harness 10 is formed of a primary strap 12. Primary strap 12 may be made of any lightweight, strong fabric, but preferably is made from automotive seat belt webbing material. Starting from first end 32 of primary strap 12 on the rear of left shoulder 28 of user 8, primary strap 12 wraps around user 8, following a path across the back of user 8 to the front of right leg 22, between right leg 22 and left leg 26 to the back of right leg 22, around the right side of user 8 underneath the arm of user 8 to right shoulder 24, across the back of user 8 again to the front of left leg 26, between left leg 26 and right leg 22 to the back of left leg 26, and around the left side of user 8 underneath the other arm of user 8 to left shoulder 28, where second end 34 of primary strap 12 attaches to first end 32. First end 32 and second end 34 of primary strap 12 are shown joined to each other adjacent to left shoulder 28 of user 8 with buckle 14, but may be permanently or releasably fastened to each other by any means well known in the art, and at any other point on primary strap 12 where it is convenient for user 8.

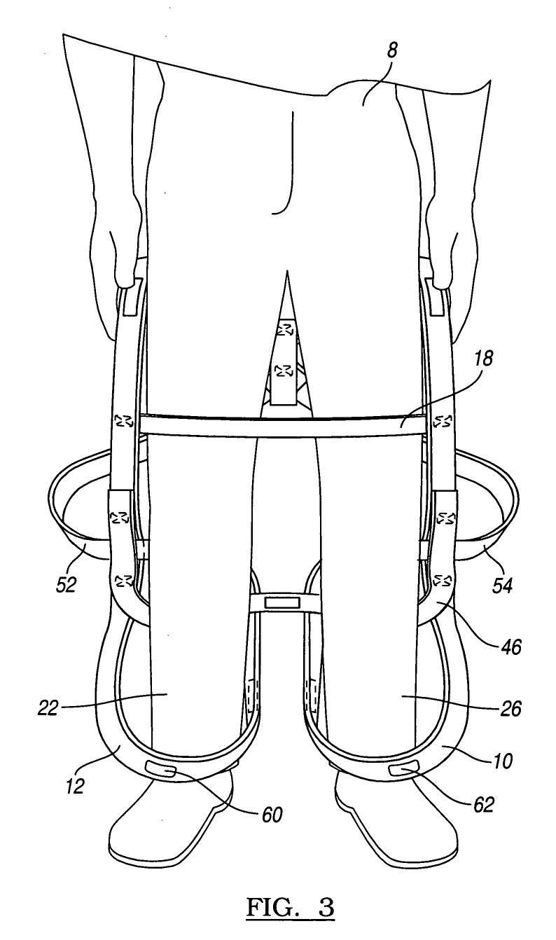

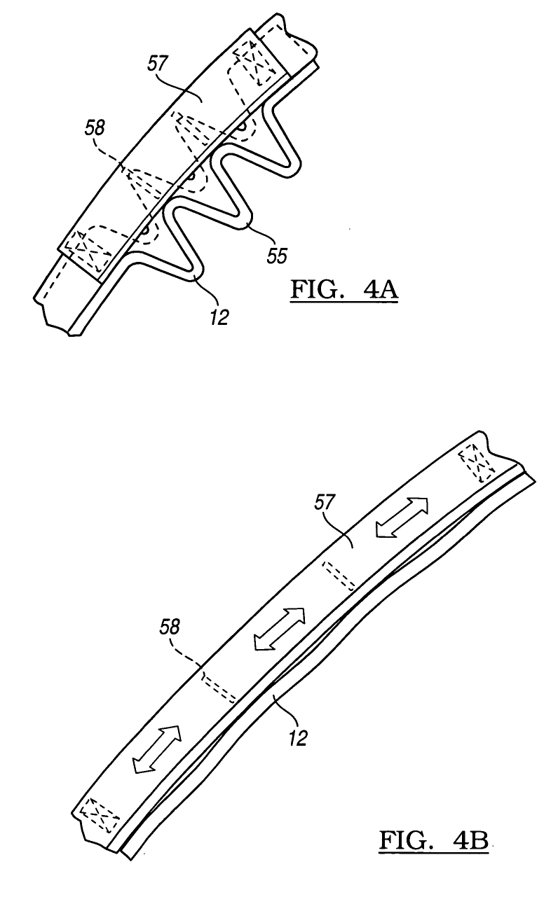

Harness 10 is adjustable to suit various sizes of user 8, and for the overall comfort of user 8. Primary strap 12 may be adjustable for overall length through any means well known in the art. Primary strap 12 is shown with self-adjustment loops 30 and 40 adjacent to left shoulder 28 and right shoulder 24. Self-adjustment loops 30 and 40 are comprised of a doubled over portion of primary strap 12, connected with elastic piece 57, which is sewn to primary strap 12 (FIG. 4). Self-adjustment loops 30 and 40 thus increase the overall comfort of harness 10 by allowing primary strap to stretch with user 8.

Elastic chest strap 18 is sewn or otherwise secured to primary strap 12 at chest strap attachment points 42 and 44. Elastic chest strap 18 guides the path of primary strap 12 around right shoulder 24 and left shoulder 28 of user 8 by urging both sides of primary strap 12 in a central direction relative to user 8 away from right shoulder 24 and left shoulder 28, respectively. Elastic chest strap 18 thus enhances the overall comfort and fit of harness 10.

Climbing strap 46 is sewn or otherwise attached to primary strap 12 at climbing strap attachment points 48 and 50, respectively. Climbing strap 46 provides support to user 8 during the operation of climbing a tree or utility pole, for example, using harness 10. Climbing strap 46 is made preferably of a similarly strong and lightweight material such as automotive seat belt webbing material, similar to primary strap 12.

D-ring loops 52 and 54 are provided for D-ring loops 52 and 54 are sewn or otherwise attached to primary strap 12 on each side of user 8. D-ring loops 52 and 54 are provided for securing climbing devices or rope to harness 10, and are typically utilized for the operation of climbing a tree or pole (not shown). D-ring loops are preferably made of a material similar to the automotive seat belt webbing used for primary strap 12 and climbing strap 46.

To assist user 8 in putting on harness 10, right shoulder label 56 and right leg label 60 may be sewn or otherwise attached to primary strap 12, in locations suggesting the placement of primary strap 12. Left shoulder label 58 and left leg label 62 are similarly attached to primary strap 12 in locations suggesting the proper placement of primary strap 12 on user 8, the locations being generally symmetrical to those of right shoulder label 56 and right leg label 60 on primary strap 12.

Turning now to FIG. 3, the operation of putting harness 10 on user 8 is described. With harness 10 laid in front of user 8, user 8 may grasp primary strap 12 adjacent to right shoulder label 56 and left shoulder label 58. User 8 may then place their right and left legs through the loops formed by primary strap 12 for right leg 22 and left leg 26, respectively, and raise harness 10 so primary strap 12 fits around the legs and shoulders of user 8 as shown in FIG. 1.

FIGS. 4A and 4B show perspective views of the self-adjusting or extension loop of the harness. As can be seen in FIG. 4A, the primary strap 12 is folded over itself so as to form a plurality of articulations 55. Disposed over the articulations is an elastic strap 57 which is sewn at predetermined points 58 of the articulations. As shown in FIG. 4B, when tension is applied to either one of the elastic strap 57 or the webbing 12, the webbing 12 elongates, thus allowing for the harness to comfortably fit users having larger proportions. While the extension portion is shown on the shoulder loop portions, it is envisioned that they can equally be used in the leg loop portions.

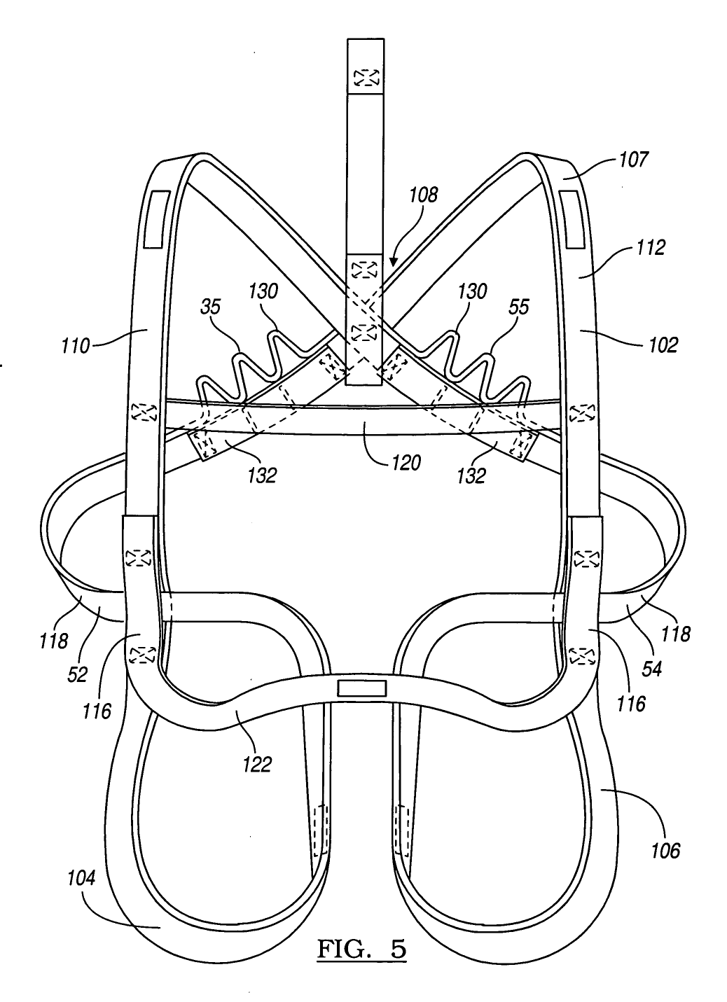

FIG. 5 represents a harness 100 according to the teachings of the present invention. The harness 100 is formed of a single main loop 102. The main loop 102 is folded a first time to form a first leg loop 104. Similarly, the main loop 102 is folded to make the second leg loop 106. Disposed between the first and second leg loops 104 and 106 is a central loop 107 which is crossed 108 to form the first and second arm support loops 110, 112. Disposed along the webbing of the arm support loops 110 and 112 are fasteners 116.

The fasteners 116 (shown in the form of an elastic webbing) function to hold the configuration of the loops in place during use. Optionally, the fasteners 116 allow for the passage of the webbing there through to allow for a customization of the harness 100. Additionally, by passing the portions of the shoulder loops through the fastener 116 twice, an optional accessory loop 118 can be formed. Chest and waist straps 120, 122 are sewn to the single main loop at the arm support loops 110, 112 and first and second leg loops 104, 106. Optionally, the chest and waist straps 120,122 can be formed of elastic material.

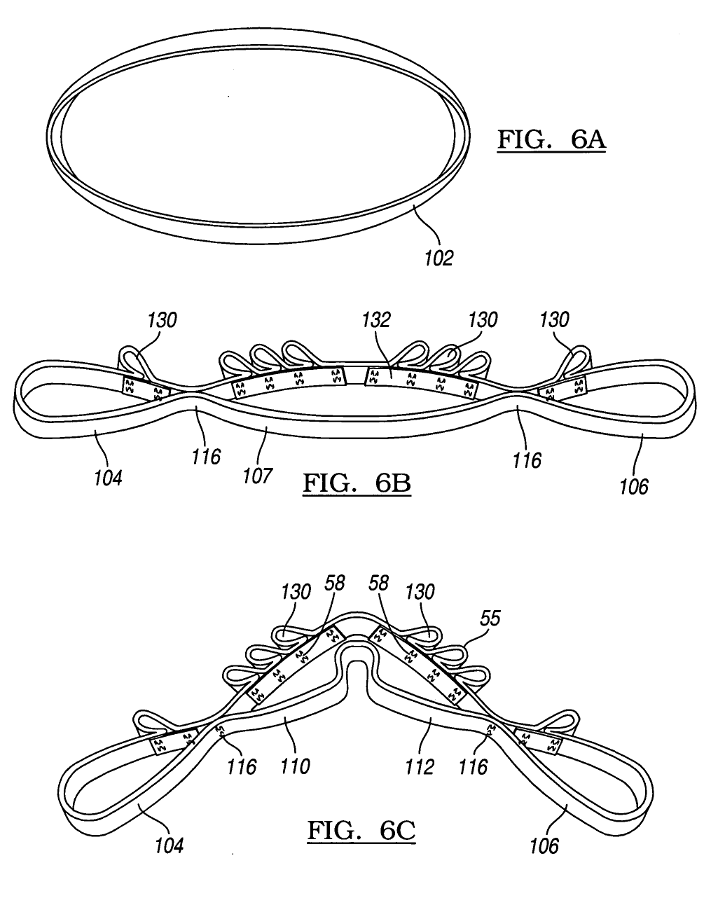

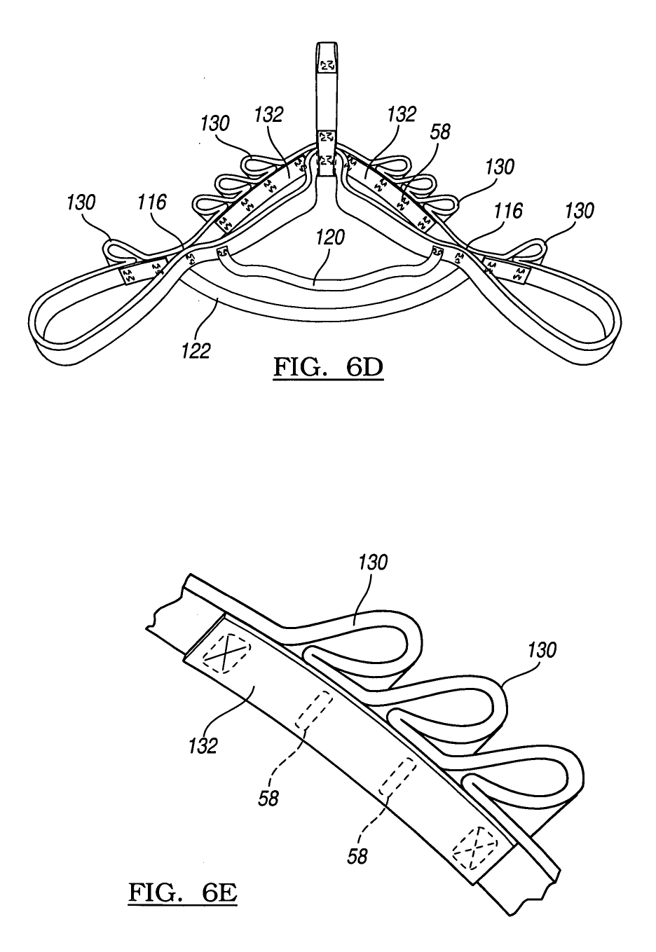

FIGS. 6A-6E depict the manufacture of the harness 100. As shown in FIG. 6A, the harness is preferably formed of a single integral loop of webbing 102. It is envisioned that this can be formed of a single piece of webbing. Those skilled in the art would, however, recognize that it can also be formed of multiple pieces stitched together to form a single main loop 102. As shown in FIG. 6B, the single loop of webbing 102 is folded over in two spots to define first 104, second 107, and third 106 loops. At locations that the webbing is folded, a fastener in the form of a loop of fabric is provided to hold the pieces relative to each other. At this point, as shown in FIG. 6C, the second loop 107 is folded over itself to define the pair of arm loops 110, 112. A strap 120, which is configured to couple the harness to a mounting mechanism, is sewn to the single loop 102 at the intersection of the fourth and fifth loops 110, 112.

As shown in FIG. 6D, a pair of elastic members 120, 122 are sewn between the fourth and fifth loops and the first and third loops. The elastic member 120 or strap sewn between the fourth and fifth loops define a chest strap while the elastic member sewn between the first and third loops 122 define a back or waist member. At this point, extension loops 130 are defined within the shoulder loops four and five as well as the leg loops one and three. As shown in FIG. 6E, a plurality of extension loops 130 can be defined in any of the webbing loops. The extension loop 130 is formed by folding a portion of the webbing over itself and by stitching an elastic fabric piece 132 to the harness webbing 102. It is envisioned that the elastic webbing 132 will be capable of elongating so as to allow the loop 130 of the extension portion to fully unfold. The elastic portion 132 is configured to intermittently allow the webbing of the extension loop to automatically refold itself when tension is not applied to either the elastic strap or the folded portion of the extension loop (see also FIGS. 4A and 4B).

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A method for forming a harness out of a single loop of webbing comprising:
folding the webbing so as to form first, second, and third loops;
sewing a ring loop at the intersection of the loops;
folding the second loop to form an intersection and define fourth and fifth loops;
sewing a first strap between the first and second loops; and
sewing a second strap between the third and fourth loops.

2. The method according to claim 1 further comprising forming at least one extension loop on each of the fourth and fifth loops.

3. The method according to claim 1 further comprising forming a seventh loop of a second webbing about the intersection.

4. The method according to claim 1 wherein forming an extension loop is folding the fourth loop and sewing an elastic material adjacent to the fourth loop.

5. The method according to claim 1 wherein sewing the first strap is sewing a first elastic strap.

6. The method according to claim 5 wherein sewing the second strap is sewing a second elastic strap.

7. A harness comprising:
a single loop of webbing folded over so as to form first, second, third, and fourth loops;
a first stitching joint defined between the first and second loops;
a second stitching joint between the third and fourth loops;
a first elastic strap coupled to the first and fourth loops; and
a second elastic strap coupled to the second and third loops.

8. The harness according to claim 7 further comprising an extension loop on said second loop.

9. The harness according to claim 7 further comprising a plurality of extension loops defined on the second and third loops.

10. The harness according to claim 9 wherein each extension loop comprises a fold of material and an elastic member disposed adjacent to the fold, wherein the elastic member allows the intermittent refolding of the extension loop depending upon tension applied to one of the extension loop or the elastic member.

11. The harness according to claim 7 further comprising a loop fastener disposed over the intersection of the second and third loops.

12. The harness according to claim 7 further comprising an extension portion defined on at least one of the first and fourth loops.

13. The harness according to claim 7 further comprising a first loop disposed about the intersection of the second and third loops.

14. A harness comprising:
a single loop of webbing folded over so as to form first, second, third, and fourth loops;
a first fastener disposed about the intersection between the first and second loops;
a second fastener disposed about the intersection between the third and fourth loops;
a first strap coupled to the first and fourth loops; and
a second strap coupled to the second and third loops.

15. The harness according to claim 14 further comprising a first extension loop on said second loop and a second extension loop on said third loop.

16. The harness according to claim 14 further comprising a plurality of extension loops defined on the second and third loops.

17. The harness according to claim 16 wherein each extension loop comprises a fold of material and an elastic member disposed adjacent to the fold, wherein the elastic member allows the intermittent refolding of the extension loop depending upon tension applied to one of the extension loop or the elastic member.

18. The harness according to claim 14 further comprising a loop of webbing disposed over the intersection of the second and third loops.

19. The harness according to claim 14 wherein the first and second fasteners are fabric sewn to the webbing.

20. The harness according to claim 14 wherein the first and second fasteners are stitches.
